(19) United States
(12) Patent Application Publication
(10) Pub. No.: US 2002/0095366 A1
(43) Pub. Date: Jul. 18, 2002

(54) Capacity auction method and system providing enhanced fabrication facility utilization

(75) Inventor: Chao-Hsin Chang, Hsin-chu city (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 09/761,283

(22) Filed: Jan. 16, 2001

(51) Int. Cl. G06F 17/60

(52) U.S. Cl. 705/37; 705/7; 705/8; 705/9; 705/10

(57) ABSTRACT

Within both a method for operating a fabrication facility and a system for operating the fabrication facility there is employed an auctioning of at least a portion of the total fabrication facility available capacity when operating the fabrication facility. By employing the auctioning of the at least the portion of the total fabrication facility available capacity the fabrication facility when operating the fabrication facility, the fabrication facility may be operated with enhanced fabrication facility utilization. The method and the system are particularly applicable to operating microelectronic fabrication facilities. Similarly, the method and the system preferably employ a distributed communications network, and in particular an Internet distributed communications network.

### BACKGROUND OF THE INVENTION

1. Field of the Invention

The present invention relates generally to fabrication facility utilization. More particularly, the present invention relates to methods and systems for providing enhanced fabrication facility utilization.

2. Description of the Related Art

As a result of the considerable technical complexity which is inherent in the fabrication of microelectronic fabrications, and in particular in the fabrication of semiconductor integrated circuit microelectronic fabrications, there exists a considerable correlating complexity in the design and fabrication of microelectronic fabrication facilities and microelectronic fabrication tooling which are employed for fabricating microelectronic fabrications. Such correlating complexity in the design and fabrication of microelectronic fabrication facilities and microelectronic fabrication tooling which are employed for fabricating microelectronic fabrications in turn generally provide for considerable capital expense for acquisition of microelectronic fabrication facilities and microelectronic fabrication tooling which are employed for fabricating microelectronic fabrications.

As an additional consideration with respect to fabricating microelectronic fabrications, and with respect more specifically to the operation of microelectronic fabrication facilities which are employed for fabricating microelectronic fabrications, there often exists considerable inefficiency in operation of microelectronic fabrication facilities which are employed for fabricating microelectronic fabrications insofar as microelectronic fabrication facilities often produce multiple microelectronic fabrication products or microelectronic fabrication product families while employing multiple microelectronic fabrication product routings which are established in support of multiple microelectronic fabrication customers whose microelectronic fabrication product needs are often variable and not readily predictable.

As a result of the considerable capital expense for acquiring microelectronic fabrication facilities and microelectronic fabrication tooling, when taken in conjunction with the variable and not readily predictable microelectronic fabrication product needs for microelectronic fabrication customers, there often results difficulties in optimizing microelectronic fabrication facility utilization, such as in turn to optimize microelectronic fabrication facility return on investment.

It is thus desirable in the art of microelectronic fabrication to provide methods and systems which in turn provide enhanced microelectronic fabrication facility utilization, such as in turn to optimize microelectronic fabrication facility return on investment.

It is towards the foregoing object that the present invention is more specifically directed.

Various methods and systems have been disclosed within various of the commercial arts for undertaking, with desirable results, various types of commercial transactions within the various of the commercial arts.

For example, Johnson et al., in U.S. Pat. No. 6,047,274, discloses a method and a system for enhancing competition within a group of energy suppliers (such as but not limited to a group of natural gas energy suppliers or a group of electric energy suppliers) such in turn as to provide for more cost competitive energy costs to a group of energy consumers (such as but not limited to a residential group of energy consumers or a commercial group of energy consumers) whose energy needs may be supplied by the group of energy suppliers. To realize the foregoing object, the method and the system employ an auction type activity amongst the group of energy suppliers, as intended to sufficiently stimulate competition amongst the group of energy suppliers such as to provide more favorable pricing to the group of energy consumers, typically within a particular energy consumer geographic region or with respect to a particular energy consumer customer set.

In addition, Chou et al., in U.S. Pat. No. 6.055,504, discloses a method and a system for accommodating electronic commerce within a communications network capacity commercial market, while simultaneously preserving proprietary information of a series of commercial player entities which participates in the communications network capacity commercial market. To realize the foregoing object, the method and the system employ a neutral third party moderator positioned as a hub within a hub and spoke arrangement with respect to each commercial player entity within the series of commercial player entities which participate in the communications network capacity commercial market, where further in turn each commercial player entity is positioned as a separate spoke within the hub and spoke arrangement, such that the neutral third party moderator may preserve an-anonymity of each commercial player entity within the series of commercial player entities within the communications network capacity commercial market.

Finally, Barni et al., in U.S. Pat. No. 6,064,981, discloses a method and a system through which shippers may more efficiently evaluate and procure, with anonymity, various carrier shipping services and freight forwarder shipping services for shipping of various goods to various locations through use of various shipping means. To realize the foregoing object, the method and the system comprise a computer assisted method and a computer assisted system wherein various shipping rates and shipping capacity data are posted, preferably within the context of a network (i.e., Internet network) website, while simultaneously providing an option for auctioning available shipping capacity.

Desirable in the art of microelectronic fabrication are additional methods and systems which may be employed for providing enhanced microelectronic fabrication facility utilization.

It is towards the foregoing object that the present invention is more specifically directed.

### SUMMARY OF THE INVENTION

A first object of the present invention is to provide a method for operating a fabrication facility and a system for operating the fabrication facility.

A second object of the present invention is to provide a method for operating the fabrication facility and a system for operating the fabrication facility in accord with the first object of the present invention, where the method for operating the fabrication facility and the system for operating the fabrication facility provide for enhanced fabrication facility utilization.

A third object of the present invention is to provide a method for operating the fabrication facility and a system for operating the fabrication facility in accord with the first object of the present invention and the second object of the present invention, wherein the method for operating the fabrication facility and the system for operating the fabrication facility are readily commercially implemented.

In accord with the objects of the present invention, there is provided by the present invention a method for operating a fabrication facility and a system for operating the fabrication facility.

To practice the method of the present invention, there is first provided a fabrication facility having a total available production capacity for producing at least one product. There is then allocated from the total available production capacity for producing the at least one product a first capacity for producing at least one specified product. There is then auctioned, while employing an auction method, the first capacity for producing the at least one specified product to a pool of bidders comprising at least one bidder. There is then determined from the pool of bidders comprising the at least one bidder at least one winning bidder. Finally, there is then fabricated, for the at least one winning bidder, a quantity of the at least one specified product from the fabrication facility while employing the first capacity for producing the at least one specified product.

The method for operating the fabrication facility in accord with the present invention contemplates a system, and in particular a computer and communications network assisted system, for operating the fabrication facility in accord with the present invention.

Within both the method for operating the fabrication facility in accord with the present invention and the system for operating the fabrication facility in accord with the present invention, there is typically and preferably employed within the auction method a distributed communications network, and more typically and preferably an Internet distributed communications network, at least for purposes of moderating an auction undertaken within the auction method.

There is provided by the present invention a method for operating a fabrication facility and a system for operating the fabrication facility, wherein the method for operating the fabrication facility and the system for operating the fabrication facility provide for enhanced fabrication facility utilization. The present invention realizes the foregoing object by auctioning, while employing an auction method, a first capacity for producing at least one specified product within a fabrication facility, as allocated from a total available production capacity for producing at least one product within the fabrication facility, when operating the fabrication facility. By auctioning the first capacity for producing the at least one specified product when operating the fabrication facility, there may theoretically be provided an enhanced fabrication facility utilization, in particular within the context of an enhanced fabrication facility economic return, under conditions where market demand for the fabrication facility products exceeds total available fabrication facility production capacity. Similarly, by auctioning the first capacity for producing the at least one specified when operating the fabrication facility, there may theoretically also be provided an enhanced fabrication facility utilization, in particular within the context of an enhanced fabrication facility capacity utilization under conditions where market demand for the fabrication facility products does not exceed total available fabrication facility production capacity.

The method of the present invention and the system of the present invention are readily commercially implemented.

As will be illustrated in greater detail within the context of the Description of the Preferred Embodiment as set forth below, the method for operating the fabrication facility in accord with the present invention and the system for operating the fabrication facility in accord with the present invention may be readily implemented within the context of computer systems and distributed communications networks, in particular such as but not limited to Internet distributed communications networks, as have become generally conventional with respect to the electronic commercial transactions arts. Since it is thus a specific application and implementation of a computer system and a distributed communications network which may at least in part provide the present invention, rather than the existence of specific computing system means and specific communications network means which provides the present invention, the method of the present invention and the system of the present invention are readily commercially implemented.

### BRIEF DESCRIPTION OF THE DRAWINGS

The objects, features and advantages of the present invention are understood within the context of the Description of the Preferred Embodiment, as set forth below. The Description of the Preferred Embodiment is understood within the context of the accompanying drawings, which form a material part of this disclosure, wherein:

FIG. 1 and FIG. 2 show a pair of schematic diagrams illustrating capacity allocation within a fabrication facility in accord, respectively, with the prior art and a preferred embodiment of the present invention.

FIG. 3 shows a diagram comprising a representation of Auction Parameters for a semiconductor integrated circuit microelectronic fabrication auction capacity auction in accord with an example of the present invention.

FIG. 4 shows a schematic block flow diagram illustrating a process flow in accord with a preferred embodiment of the present invention.

### DESCRIPTION OF THE PREFERRED EMBODIMENT

There is provided by the present invention a method for operating a fabrication facility and a system for operating the fabrication facility, wherein the method for operating the fabrication facility and the system for operating the fabrication facility provide for enhanced fabrication facility utilization. The present invention realizes the foregoing object by auctioning, while employing an auction method, a first capacity for producing at least one specified product within a fabrication facility, as allocated from a total available production capacity for producing at least one product within the fabrication facility, when operating the fabrication facility. By auctioning the first capacity for producing the at least one specified product when operating the fabrication facility, there may theoretically be provided an enhanced fabrication facility utilization, in particular within the context of an enhanced fabrication facility economic return, under conditions where market demand for the fabrication facility products exceeds total available fabrication facility production capacity. Similarly, by auctioning the first capacity for producing the at least one specified product when operating the fabrication facility, there may theoretically also be provided an enhanced fabrication facility utilization, in particular within the context of an enhanced fabrication facility capacity utilization under conditions where market demand for the fabrication facility products does not exceed total available fabrication facility production capacity.

While the present invention provides particular value within the context of providing for enhanced fabrication facility utilization when operating a microelectronic fabrication facility, and in particular a semiconductor integrated circuit microelectronic fabrication facility, the present invention may nonetheless provide for enhanced fabrication facility utilization when operating fabrication facilities employed for fabricating products including but not limited to electrical products, mechanical products, chemical products, electro-mechanical products and microelectronic products. Within fabrication facilities employed for fabricating microelectronic products, the present invention may be employed within fabrication facilities employed for fabricating microelectronic fabrications selected from the group including but not limited to integrated circuit microelectronic fabrications, ceramic substrate microelectronic fabrications, solar cell optoelectronic microelectronic fabrications, sensor image array optoelectronic microelectronic fabrications and display image array optoelectronic microelectronic fabrications. Most typically and preferably, the present invention is employed for providing enhanced fabrication facility utilization within semiconductor integrated circuit microelectronic fabrication facilities employed for fabricating semiconductor integrated circuit microelectronic fabrications.

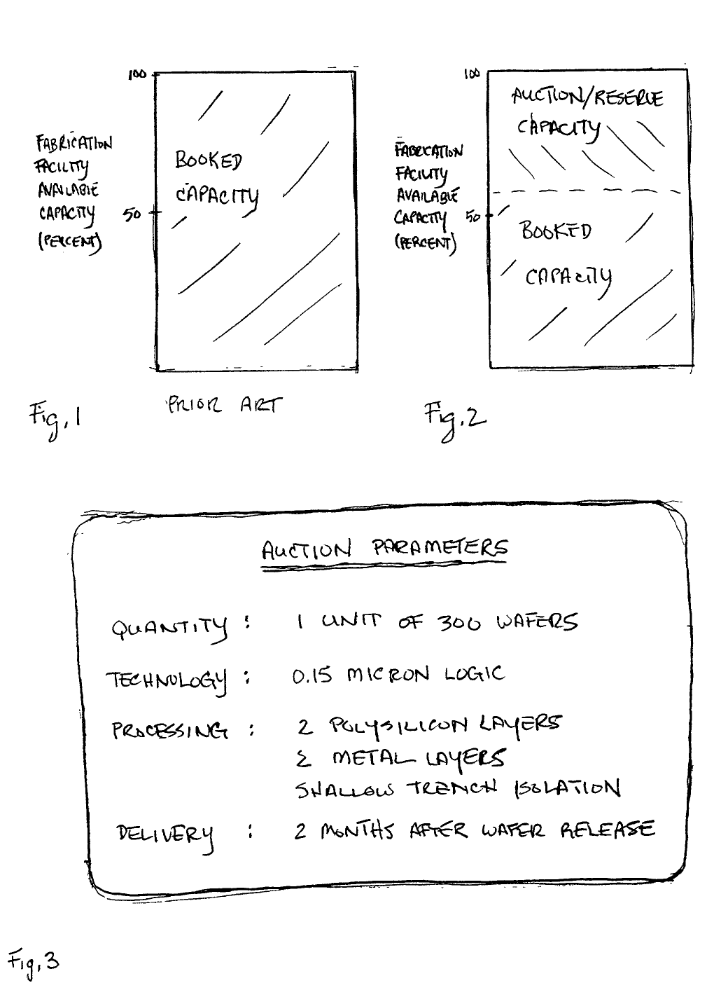

Referring now to FIG. 1, there is shown a schematic block diagram illustrating capacity allocation within a fabrication facility in accord with the prior art.

As is illustrated within the schematic diagram of FIG. 1, typically and preferably, it is desirable to entirely book fabrication facility available capacity within a fabrication facility to provide a booked capacity within the fabrication facility such as to provide for enhanced utilization of the fabrication facility. Within the context of a microelectronic fabrication facility, booking of the microelectronic fabrication facility available capacity is typically and preferably undertaken within the context of negotiations between an individual customer, which will typically and preferably be an individual corporate customer, and microelectronic fabrication facility representatives, such as but not limited to microelectronic fabrication facility marketing representatives and microelectronic fabrication facility production representatives. Within the preferred embodiment of the present invention fabrication facility available capacity may be booked within the context of customer driven constraints and/or fabrication facility driven constraints including but not limited to customer supply needs and/or total fabrication facility available capacity, either of which being determined over any of several negotiated time scales. Similarly, fabrication facility available capacity may be booked within the context of product types including but not limited to industry standard product types, semi-custom product types and custom product types, any of which may individually or in an aggregate book fabrication facility available capacity.

As is understood by a person skilled in the art, while the block diagram of FIG. 1 illustrates an ideal condition where a fabrication facility available capacity is completely booked to total fabrication facility available capacity and only booked to total fabrication facility available capacity, such an ideal situation is generally not encountered with respect to fabrication facilities, and in particular with respect to microelectronic fabrication facilities. Rather, with respect in particular to microelectronic fabrication facility available capacity, microelectronic fabrication facility available capacity is generally either: (1) overbooked, where microelectronic fabrication facility available capacity is more than totally booked; or (2) underbooked, where microelectronic fabrication facility available capacity is not completely booked. The first of the foregoing scenarios is generally economically inefficient with respect to a microelectronic fabrication facility insofar as the overbooked microelectronic fabrication available capacity will generally cause a delay in microelectronic product order fulfillment and concomitant microelectronic fabrication customer dissatisfaction. Similarly, the second of the foregoing scenarios is generally also economically inefficient with respect to a microelectronic fabrication facility insofar as unused microelectronic fabrication facility available capacity clearly provides for an unrecoverable loss in microelectronic fabrication facility revenue.

Referring now to FIG. 2, there is shown a schematic diagram illustrating capacity allocation within a fabrication facility in accord with a preferred embodiment of the present invention.

In accord with the schematic diagram of FIG. 2, there is first provided with respect to a fabrication facility available capacity a booked capacity which may be booked employing methods as are otherwise analogous or equivalent to the methods as are employed for providing the booked capacity within the fabrication facility available capacity as illustrated within the schematic diagram of FIG. 1, but wherein the booked capacity is less than the total fabrication facility available capacity.

Shown also within the schematic diagram of FIG. 2 is an auction/reserve capacity which in conjunction with the booked capacity provides for the total fabrication facility available capacity within the fabrication facility.

Within the context of the present invention, it is in particular the auction/reserve capacity with respect to the total fabrication facility available capacity which provides at least in part the present invention.

Referring now to FIG. 4, there is shown a schematic block flow diagram illustrating a process flow in accord with a preferred embodiment of the present invention.

Shown in FIG. 4, and in conjunction with the block which corresponds with reference numeral 40, there is first provided a fabrication facility.

As noted above, the fabrication facility as provided in accord with the block which corresponds with reference numeral 40 may be employed for fabricating products including but not limited to electrical products, mechanical products, chemical products, electro-mechanical products, but more particularly microelectronic products and most particularly semiconductor integrated circuit microelectronic fabrication products.

Referring again to the schematic block flow diagram of FIG. 4, and in accord with the block which corresponds with reference numeral 42, there is then established a booked capacity, an auction/reserve capacity and an auction capacity for the fabrication facility. The booked capacity for the fabrication facility may be established employing any of several methods as are discussed above in conjunction with the discussion of FIG. 2. Similarly, the auction/reserve capacity may be determined employing any of several methods, and in conjunction with the booked capacity will typically and preferably not exceed the total fabrication facility available capacity for the fabrication facility, but may equal the total fabrication facility available capacity for the fabrication facility. During periods of increased market demand for products fabricated within the fabrication facility, it may be desirable to determine an auction/reserve capacity for the fabrication facility within a range of from about 0 to about 20 percent of the total fabrication facility available capacity of the fabrication facility, while during periods of decreased market demand for products fabricated within the fabrication facility it may be desirable to determine an auction/reserve capacity of from about 0 to about 50 percent of the total fabrication facility available capacity of the fabrication facility. Within the preferred embodiment of the present invention, the auction/reserve capacity is intended to include the auction capacity which is intended to be auctioned, as well as an optional reserve capacity which may be included for purposes of accommodating fabrication facility operation problems and/or otherwise unallocated special requests from existing fabrication facility customers within the context of fabrication facility booked capacity.

Referring again to the schematic block flow diagram of FIG. 4, and in accord with the block which corresponds with reference numeral 44, there is then auctioned the auction capacity portion of the total fabrication facility available capacity.

Within the preferred embodiment of the present invention, the auction capacity of the total fabrication facility available capacity may be auctioned while employing auction methods and auction formats as are otherwise generally conventional within any of several auction arts, including but not limited to English auction methods and auction formats, Dutch auction methods and auction formats, reserve auction methods and auction formats, non-reserve auction methods and auction formats, sealed bid auction methods and auction formats and Vickrey auction methods and auction formats. Significant to the present invention is that the auction of the auction capacity portion of the total fabrication facility available capacity is typically and preferably undertaken employing a computer system and a distributed communications network as an auction moderator tool, wherein the distributed communications network is typically and preferably an Internet distributed communications network.

Referring again to FIG. 4, and in accord with the block which corresponds with reference numeral 46, there is then determined if there exists a winning bidder with respect to auction of the auction capacity as illustrated in conjunction with the block which corresponds with reference numeral 46. If there exists no winning bidder, and in accord with the block which corresponds with reference numeral 50, the auction is ended. Similarly, if there exists at least one winning bidder (and possibly multiple winning bidders), and in accord with the block which corresponds with reference numeral 48, at the auction/reserve capacity and the auction capacity of the total fabrication facility available capacity are appropriately adjusted.

Although not specifically illustrated within the schematic block flow diagram of FIG. 4, upon determination of existence of a winning bidder, a winning bid price simultaneously determined may also be employed for establishing a non-auction capacity (i.e., a booked capacity and/or a reserve capacity) pricing for existing or subsequent orders within the fabrication facility.

Referring again to FIG. 4, and in accord with the block which corresponds with reference numeral 52, there is then communicated to the winning bidder(s) appropriate technical clarification(s) and order confirmation(s). Such technical clarification(s) and order confirmation(s) may be communicated to the winning bidder(s) while similarly employing the computer system and distributed communications network, and in particular the Internet distributed communications network, as employed for undertaking the auction as illustrated in conjunction with the block which corresponds with reference numeral 44.

Referring again to FIG. 4, and in accord with the block which corresponds with reference numeral 54, there is then fabricated product within the fabrication facility while employing the auction capacity.

Referring finally again to FIG. 4, and in accord with the block which corresponds with reference numeral 56, the winning bidder(s) order(s) is (are) then fulfilled (i.e., shipped and invoiced) to the winning bidder(s) while employing product fabricated using the auction capacity.

Upon completion of the process steps corresponding with the blocks which correspond with the schematic block flow diagram of FIG. 4, there is provided a method for operating a fabrication facility and a system for operating the fabrication facility, wherein within the method for operating the fabrication facility and the system for operating the fabrication facility the fabrication facility provides for enhanced fabrication facility utilization. The method for operating the fabrication facility in accord with the present invention and the system for operating the fabrication facility in accord with the present invention realize the foregoing object by auctioning at least part of the total fabrication facility available capacity within the fabrication facility when fabricating a product within the fabrication facility.

### EXAMPLE

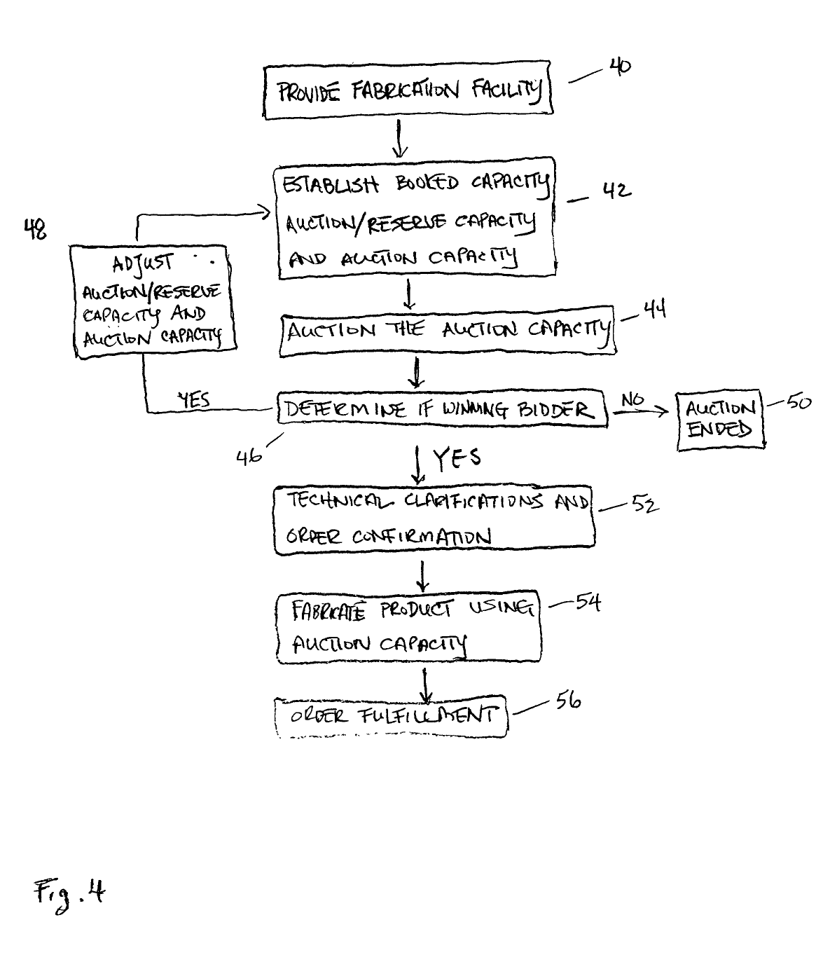

Shown within FIG. 3 is diagram comprising a representation of various auction parameters which might be included within a graphical user interface web page within an Internet distributed communications network for purposes of auctioning a portion of the total fabrication facility available capacity within a semiconductor integrated circuit microelectronic fabrication facility.

As is illustrated within the diagram of the representation of the graphical user interface web page as illustrated within the diagram of FIG. 3, there is provided various auction parameters, including: (1) a quantity of one unit of 300 wafers; (2) a technology of 0.15 micron logic; (3) a listing of processing parameters including 2 polysilicon layers, 2 metal layers and shallow trench isolation; and (4) an anticipated delivery of 2 months after wafer release.

As is understood by a person skilled in the art, there will typically and preferably be included a greater number of auction parameters and a greater amount of information with respect to auction capacity within a semiconductor integrated circuit microelectronic fabrication facility in comparison with the auction parameters and information as provided within the representation within the diagram of FIG. 3, such as to provide for sufficient information such that an informed customer may place an informed bid within an auction for the auction capacity within the semiconductor integrated circuit microelectronic fabrication facility. Thus, the auction parameters as illustrated within the diagram of FIG. 3 are by no means limiting of the present invention, particularly as relates to auctioning of auction capacity within a semiconductor integrated circuit microelectronic fabrication facility.

As is further understood by a person skilled in the art, the preferred embodiment and example of the present invention are also generally illustrative of the present invention rather than limiting of the present invention. Revisions and modifications may be made to methods and systems as disclosed within the preferred embodiment and example of the present invention while still providing a method for operating a fabrication facility and a system for operating the fabrication facility in accord with the present invention, further in accord with the accompanying claims.

What is claimed is:

1. A method for operating a fabrication facility comprising:
providing a fabrication facility having a total available production capacity for producing at least one product;
allocating from the total available production capacity for producing the at least one product a first capacity for producing at least one specified product;
auctioning, while employing an auction method, the first capacity for producing the at least one specified product to a pool of bidders comprising at least one bidder;
determining from the pool of bidders comprising the at least one bidder at least one winning bidder; and
fabricating, for the at least one winning bidder, a quantity of the at least one specified product from the manufacturing facility while employing the first capacity for producing the at least one specified product.

2. The method of claim 1 wherein the at least one product is selected from the group consisting of mechanical products, electrical products, chemical products and electro-mechanical products.

3. The method of claim 1 wherein the at least one product is a microelectronic product selected from the group consisting of integrated circuit microelectronic fabrications, ceramic substrate microelectronic fabrications, solar cell optoelectronic microelectronic fabrications, sensor image array optoelectronic microelectronic fabrications and display image array optoelectronic microelectronic fabrications.

4. The method of claim 1 wherein the first capacity for producing the at least one specified product is equal to the total available capacity for producing the at least one product.

5. The method of claim 1 wherein the first capacity for producing the at least one specified product is less than the total available capacity for producing the at least one product.

6. The method of claim 1 wherein the auction is selected from the group consisting of English auctions, Dutch auctions, reserve auctions, non-reserve auctions, sealed bid auctions and Vickrey auctions.

7. The method of claim 1 wherein:
the first capacity for producing at least one specified product is less than the total available capacity for producing the at least one product; and
a winning auction price determined from the at least one winning bidder is employed for establishing a pricing of a non-auction capacity within the total available capacity for producing the at least one product.

8. The method of claim 1 wherein the auction is undertaken employing as a moderator tool a distributed communications network.

9. A system for operating a fabrication facility comprising:
means for allocating within a fabrication facility, from a total available production capacity for producing at least one product within the fabrication facility, a first capacity for producing at least one specified product within the fabrication facility;
means for auctioning, while employing an auction method, the first capacity for producing the at least one specified product to a pool of bidders comprising at least one bidder;
means for determining from the pool of bidders comprising the at least one bidder at least one winning bidder; and
means for effecting fabrication, for the at least one winning bidder, of a quantity of the at least one specified product from the manufacturing facility while employing the first capacity for producing the at least one specified product.

10. The system of claim 9 wherein the at least one product is selected from the group consisting of mechanical products, electrical products, chemical products and electro-mechanical products.

11. The system of claim 9 wherein the at least one product is a microelectronic product selected from the group consisting of integrated circuit microelectronic fabrications, ceramic substrate microelectronic fabrications, solar cell optoelectronic microelectronic fabrications, sensor image array optoelectronic microelectronic fabrications and display image array optoelectronic microelectronic fabrications.

12. The system of claim 9 wherein the first capacity for producing the at least one specified product is equal to the total available capacity for producing the at least one product.

13. The system of claim 9 wherein the first capacity for producing the at least one specified product is less than the total available capacity for producing the at least one product.

14. The system of claim 9 wherein the auction is selected from the group consisting of English auctions, Dutch auctions, reserve auctions, non-reserve auctions, sealed bid auctions and Vickrey auctions.

15. The system of claim 9 wherein:
the first capacity for producing the at least one specified product is less than the total available capacity for producing the at least one product; and
a winning auction price determined from the at least one winning bidder is employed for establishing a pricing of a non-auction capacity within the total available capacity for producing the at least one product.

16. The system of claim 9 wherein the auction is undertaken employing as a moderator tool a distributed communications network.
